(19) United States
(12) Patent Application Publication
(10) Pub. No.: US 2007/0283251 A1
(43) Pub. Date: Dec. 6, 2007

(54) Web-based experience editor in a recursive browser system and uses thereof

(76) Inventor: Joseph Pally, Katy, TX (US)

Correspondence Address: Benjamin Aaron Adler;ADLER & ASSOCIATES, 8011 Candle Lane, Houston, TX, 77071, US

(21) Appl. No.: 11/443,939

(22) Filed: May 31, 2006

(51) Int. Cl. G06F 17/00; G06F 15/00

(52) U.S. Cl. 715/530

(57) ABSTRACT

Provided herein is a recursive browser system including a recursive web browser and means for interactively editing content within the recursive browser window using a thin web-browser based environment or zCubes. Also provided are user-implemented methods of interactively manipulating content within a recursive browser environment.

Computer program listings are submitted on compact disc in compliance with 37 C.F.R. §1.96 and are incorporated by reference herein. A total of two (2) compact discs (including duplicates) are submitted herein. The files on each compact disc are listed below:

| Files | Size (KB) | Date Created |
|---|---|---|
| RecursiveBrowserCode.txt | 40 | May 29, 2006 |
| zBox.txt | 48 | May 29, 2006 |
| Handwriting.txt | 76 | May 29, 2006 |

### BACKGROUND OF THE INVENTION

1. Field of the Invention

The present invention relates generally to the fields of computer technology and web browser systems. More specifically, the present invention provides a system and method to integrate media and to manipulate content within a recursive browser environment.

2. Description of the Related Art

The Internet is arguably the most important innovation of the computer generation. To browse or surf the World Wide Web (the Web) is the fastest and most popular method of obtaining information today. However, current web browsers are primarily read only with little interactive capability. The Internet is “go to and visit” and not part of the experience. A user's experience on the Internet is a temporal series of URLs visited. Furthermore, group collaboration on the Web requires user authentication and is generally site specific.

In addition most users are interested only in snippets of a web site they visit. However, a user must open a word processing, drawing or similar application or access another website to utilize or build on these snippets, if desired, or, for example, to create a document or image de novo. Browsers lack the ability to integrate different types of media according to user preferences. Selective access is missing. A live web is not close to being a reality.

Creating a new browser to address these problems is not an easy solution. It is estimated that a new browser release can cost from $10 million to $100 million. In addition the development and release processes are extremely time consuming. As such, one solution is to use the browser itself to expand browser functionalities.

Thus, there is a significant need in the art for improvements in the area of user-driven experiences. Specifically, the present invention is deficient in systems and methods to display, manipulate and/or create content in a recursive browser environment. The present invention fulfills this long-standing need and desire in the art.

### SUMMARY OF THE INVENTION

The present invention is directed to a recursive browser system. The recursive browser system comprises a recursive web browser configured to recursively display one or more web pages in a browser window thereof, means for interactively editing content within the browser window and means for storing the edited content on a computer storage medium. In a related invention the recursive browser system further comprises means for launching a user-requested action.

The present invention also is directed to a recursive web browser. The recursive web browser comprises a browser window configured to recursively display one or more web pages, means for launching a user-requested action, means for interactively editing content within the browser window, and means for storing the edited content on a computer storage medium.

The present invention is directed further to a user-implemented method for interactively manipulating content within a recursive browser environment. The user-implemented method comprises dragging and dropping one or more web objects as one or more zBoxes or zFrames within a browser window of the recursive web browser described herein thereby interactively manipulating the content within the recursive browser environment.

In a related invention the user-implemented method further comprises positioning the zBox(es) or zFrame(s) at any user-determined location within the browser window. In another related invention the object(s) is a hyperlink or URL dropped as a zBox and the method further comprises retrieving and displaying the web page(s) associated with the hyperlink(s) or URL(s) in one or more zFrames. In yet another related invention the object(s) is text or an image and the method further comprises displaying the object(s) in a zFrame within the browser window. In yet another related invention the object(s) is an action(s) dropped in a zBox and the method further comprises implementing the action(s) within the browser window. In still another related invention the method further comprises saving one or more of the object(s) as one or more files, zBlocks, or emails or to other computer-storage media. Alternatively, the entirety of the objects is saved as a retrievable user-interactive zPage.

The present invention is directed further still to a user-implemented method for interactively manipulating content within a recursive browser environment. The method comprises opening one or more zFrames, zBoxes, zCubes or a combination thereof within a browser window of the recursive web browser described herein and adding one or more user-created objects therein, thereby interactively manipulating the content within the recursive browser environment. In a related invention the user-implemented method further comprises positioning the zFrames at any user-determined location within the browser window. In another related invention the user-implemented method further comprises saving one or more of the object(s) as one or more files, zBlocks, or emails or other media or the entirety of the objects as a retrievable user-interactive zPage.

Other and further aspects, features and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIG. 1A is a flowchart illustrating the life cycle of a zBox.

FIG. 1B is a flowchart illustrating the double-click, drag and drop functions of the zEditor in creating a zBox.

FIG. 1C is a flowchart illustrating the lifecycle of a zPage.

FIG. 2A depicts a zBrowser window displaying content for assorted media.

FIG. 2B depicts a zBrowser window illustrating an example of positioning of content and zBoxes within the zBrowser page.

### DETAILED DESCRIPTION OF THE INVENTION

In one embodiment of the present invention there is provided a recursive browser system, comprising a recursive web browser configured to recursively display one or more web pages in a browser window thereof; means for interactively editing content within the browser window; and means for storing the edited content on a computer storage medium. Further to this embodiment the method comprises means for launching a user-requested action. In this further embodiment the means for launching a user-requested address action may be an action bar within a recursive browser window or may be an address bar located in a browser platform associated with the recursive web browser which triggers the action bar.

In these embodiments the means for editing content comprises a process for dragging and dropping one or more web objects or html code into the browser window and transforming the object(s) or html code into one or more zBoxes or zCubes; or a process for creating an object within said browser window; or a combination thereof. Also, the editing means may further comprise a process for displaying the dropped object(s) within the zBox(es) or zFrames. In addition the editing means may further comprise a process for user-implemented positioning of the said zBox(es) or zFrame(s) within the browser window. Furthermore, the editing means may further comprise a process for separately saving one or more of said zBox(es) or zFrames containing said dropped object(s) as a file, a zBlock or an email or other media. Alternatively, the editing means may further comprise a process for saving the entirety of said said zBox(es) or zFrame(s) within the browser window as a retrievable user-interactive zPage.

In all these embodiments the dropped object may be a hyperlink or URL, script, an action or a locator contained within a zBox in said browser window. Also, in all embodiments the dropped object may be a text or an image displayed within a zBox or zFrame in the browser window. In addition, user-created object may be a text or a drawing or handwritten content in VML, VRML or SVG.

In another embodiment of the present invention there is provided a recursive web browser, comprising a browser window configured to recursively display one or more web pages therewithin; means for launching a user-requested address or action; means for interactively editing content within the browser window; and means for storing the edited content to a computer storage medium. In this embodiment the means for launching a user-requested address action may be an action bar within a recursive browser window or may be an address bar located in a browser platform associated with the recursive web browser which triggers the action bar. In these embodiments the means and processes for editing content and the dropped objects and user-created objects are as described supra.

In yet another embodiment of the present invention there is provided a user-implemented method for interactively manipulating content within a recursive browser environment, comprising dragging and dropping one or more web objects as one or more zBoxes or zFrames within a browser window of the recursive web browser described herein thereby interactively manipulating the content within the recursive browser environment.

Further to this embodiment the method comprises positioning the zBoxes at any user-determined location within the browser window. Further still to these embodiments the user-implemented method comprises saving one or more of the zBoxes or zFrames as one or more files, emails or other media or the entirety of the zBoxes and zFrames as a retrievable user-interactive zPage. In an aspect of these embodiments the object(s) is a hyperlink or URL dropped as a zBox, the method further comprising retrieving and displaying the web page(s) associated with the hyperlink(s) or URL(s) in one or more zFrames. In another aspect the object(s) is a text or an image, the method further comprising displaying the object(s) in a zFrame within the browser window. In yet another aspect the object(s) is an action dropped in a zBox, the method further comprising implementing the action(s) within the browser window or within the zFrames therein. An action may be an event model, a script model, drag-drop formatting, or style formatting.

In still another embodiment of the present invention there is provided a user-implemented method for interactively manipulating content within a recursive browser environment, comprising opening one or more zFrames, zBoxes, zCubes or a combination thereof within a browser window of the recursive web browser described herein; and adding one or more user-created objects therein, thereby interactively manipulating the content within the recursive browser environment. In this embodiment the recursive browser environment may comprise zCubes.

Further to this embodiment the method comprises positioning the zFrames at any user-determined location within the browser window. Further yet in this embodiment the method comprises saving one or more of said zFrames as one or more files, zBlocks or emails or to other computer storage media or saving the entirety of the objects as a retrievable user-interactive zPage. In all these embodiments the recursive browser environment may comprise zCubes. Also, in all embodiments the object(s) may be a text, a drawing or handwritten content using VML, VRML or SVG.

As used herein, the term “a” or “an” may mean one or more. As used herein in the claim(s), when used in conjunction with the word “comprising”, the words “a” or “an” may mean one or more than one. As used herein “another” or “other” may mean at least a second or more of the same or different claim element of components thereof.

As used herein, the term(s) “recursive browser” or “zBrowser” refers to a browser that uses existing browsers to enhance their functionality and to provide 3 dimensional multipart full browser functionality to improve browser experience

As used herein, the term “Action Bar” refers to a targeting bar, which may be the conventional URL bar, that can also be triggered from html or :href calls invoking, e.g., one or more web actions, web sites, web services, or action triggers.

As used herein, the term(s) “zBox” refers to a part of a zPage that contains an html object(s), for example, but not limited to, images, scripts, shockwave, and a recursive browser. zBoxes are copiable and individually and selectively formattable with drag-drop of style text.

As used herein, the term(s) “zPage” or “zBrowser page” refers to a container of zBoxes that encompasses logic to display, edit, move, browse, and run scripts within the recursive browser. Parts of a zPage are copyable and individually and selectively formattable with drag-drop of style text. A zPage can be controlled by Zebra, i.e. zBox algebra, and is composed from data (that could be stored separately) with logic coming from the zCube server files. zPage can receive and conduct Jumping-Jax (dynamically obtained server based javascripts), effecting dynamic page maintenance.

As used herein, the term(s) “zEditor” refers to a zPage that is a page, either local or on the web, primarily composed of HTML, which allows parts of the page, e.g., z-boxes, which may be shared by groups of users, groups of z-boxes, window layer, or background-layer, to be selected, edited, or dragged-and-dropped, to effect creation of new objects upon demand, by dragging-dropping, double-clicking, or pasting, based on instructions of the incoming HTML or script of diverse media, to receive events from and into individual zBoxes and routing them, to contain zBrowser(s), VML, SVG or other handdrawings/handwritings with pointers to remote or local z-boxes or with individually addressable z-boxes or controls.

As used herein, the term(s) “zCube” refers to a collection of zBoxes contained within a zPage. A zCube may be made from templates that are stored in a gallery.

As used herein, the term(s) “zCube world” refers to one or more sets of zCube collections displayed under one context to the user. A zCube world may contain zPages.

The present invention provides a system and method for displaying and manipulating content within a recursive browser environment. The system and method disclosed herein utilize zCubes which is a thin web-browser based environment without add-ins or plug-ins such as Shockwave. A zCubes environment allows a user to integrate a wide variety of media, to manage content and to save and to store content. Particularly, the zCubes environment has the capabilities of a fully functional browser, a web content editor, photo management, multi-media integration, handwriting, JS scripting, QJax for client driven calls, and Jumping Jax for server driven calls. The zCubes provide support for containing any activeX enabled application, for example, but not limited to, PDF, Excel or Visio.

Within a recursive browser window, zCubes enables infinite page size in the x-, y- and z-directions, linked zBoxes and addressable zBoxes. Also, zCubes supports zBox Algebra or Zebra. This enables arithmetical operations, i.e., adding, subtracting, multiplying and dividing, to be performed along with actions such as, but not limited to, merging, swapping, deleting, and copying. Both zBox and zCubes can be script driven or implemented with drag/drop processes.

The recursive browser comprises an Action Bar within the zBrowser window or page as an entry point for any retrievable URL or executable action trigger within the zBrowser environment. The zBrowser is enabled to recursively display one or more web sites and/or web pages within the browser window. Furthermore, a user may browse or interact within a displayed web site and/or display any web page linked to a URL within the browser window or retrieve any content by utilizing the action bar, by utilizing a conventional URL bar or by opening a zBox.

The present invention also provides a web-based experience editor or zEditor providing interactive content editing within the page or from outside the page. Generally, a zEditor allows a user to retrieve and display web content including, inter alia, web pages, images, and video and audio files, to create user content, interact with other users in real time via chat, blogs, forums, newsgroups, or email all within a single browser window.

As such, the zEditor provides a “drag and drop” functionality such that any object may be double-clicked on and dropped into the browser page and transformed to a zBox or zCube. The object may be an action, such as, but not limited to, an event model, a script model, drag-drop formatting, or style formatting, such as, for example, shapes and colors. A zCube has the ability to raise events, e.g., a message not to close itself and is configured to provide this information to another zCube. In addition, should two or more users have the same zBox or zCube, i.e., zBlock, displayed concurrently, then user-added information to one zBlock will automatically update the others.

Also, a link within a web page or the URL for the web page itself may be dragged to the browser page. Clicking on the link or URL in the zBox or zCube will open the associated web page in another zFrame which is contained within a zNote within the browser window. Furthermore, any object within a web page, for example, but not limited to, a text or an image may be dragged to the browser page and displayed within a zBox or zFrame. The zBoxes and zFrames are positionable anywhere within the browser window at any user-determined x-, y- or -z layer. In addition, it is contemplated that zBoxes and zFrames are positionable in time because of scripting thus effectively implementing 4D pages.

An edited zBrowser page may be saved in html format, without most of the logic that enables the zBrowser to behave as it does, i.e., the data may be stored separately from the logic of the web page. The zPage or one or more zBoxes or zFrames contained within the zPage may be saved or stored on a local harddisk or local machine, to the Internet on a server, or as an email or to any computer storage medium known and standard in the art. Also, the zBoxes or zFrames may be saved as zBlocks especially when shared concurrently with other users.

The edited zBrowser page can be sent to others as pure text. Alternatively, the edited zBrowser page may be saved onto a removable media, for example, but not limited to, a jumpdrive. Also, saved files can be retrieved by opening them and making them live by passing the contents, either automatically or manually, to a suitable web site to rearchive the fully functional z-behavior. The links on the z-Edited page or zPage, when clicked, retrieves and displays the URL in a frame contained within the page, effecting an in-frame or zFrame experience.

Furthermore, zEditor functionality allows the user to create their own web content. A user may create his own web content, i.e., a user has the ability to draw an object or to compose in a manner similar to handwriting using, for example, the mouse. The created object may be saved as a webpage or zPage for reading using a browser. 2-D and 3-D objects may be created and subsequently moved and/or resized using zCubes without help from activeX or other embedded media. This technology may use VML, VRML or SVG. The created webcontent, such as fully handwritten pages or hand-created drawings, can interact with zbox concepts, can be saved to a server, local file, or as email.

Each zBox independently may be sized, layered, positioned, formatted, zoomed or unzoomed, scripted, copied, swapped, deleted and extracted. A zBox may comprise any arbitrary HTMLI, applications, recursively included zBoxes or browser components. Also, a zBox can wrap any arbitrary HTML. A zBox also may represent actions, triggers or locators performable on the Web.

One or more zBoxes float and function within a zCubes world. A zCube world is contained within a recursive web page, i.e., a zPage or document, i.e., a zDoc. It is contemplated that each zPage could be later considered as a hierarchy of zCubes world due to the recursive containment within the browser window. Both a zPage or zDoc may be saved to any media. A zCubes world is stored and retrieved therefrom. Both zBoxes and zPages have a lifecycle where each are at least able to be created, edited, saved, retrieved or deleted, or, if applicable, submitted to a server, e.g., a zCubes server. A zPage may comprise one or more zBoxes or other multi-media objects.

As described herein, the invention provides a number of advantages and uses. Embodiments of the present invention are better described below with reference to the Figures, however, such description or reference is not meant to limit the present invention in any fashion. The embodiments and variations described in detail herein are to be interpreted by the appended claims and equivalents thereof.

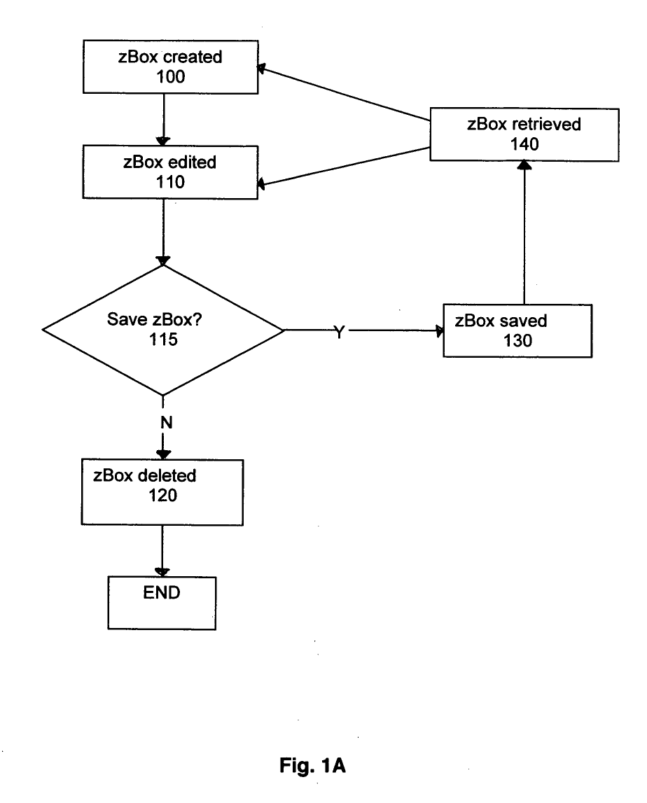

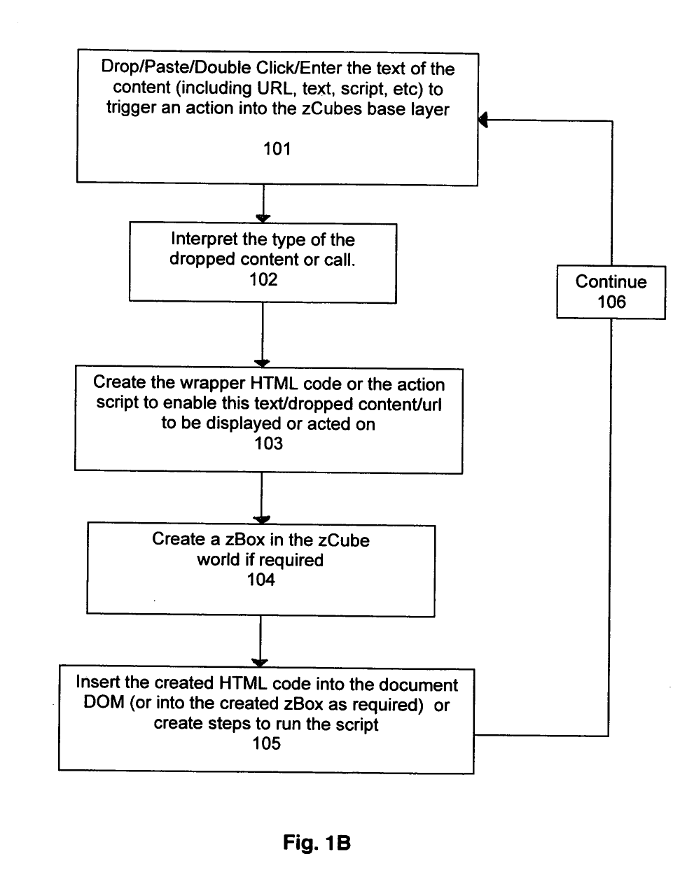

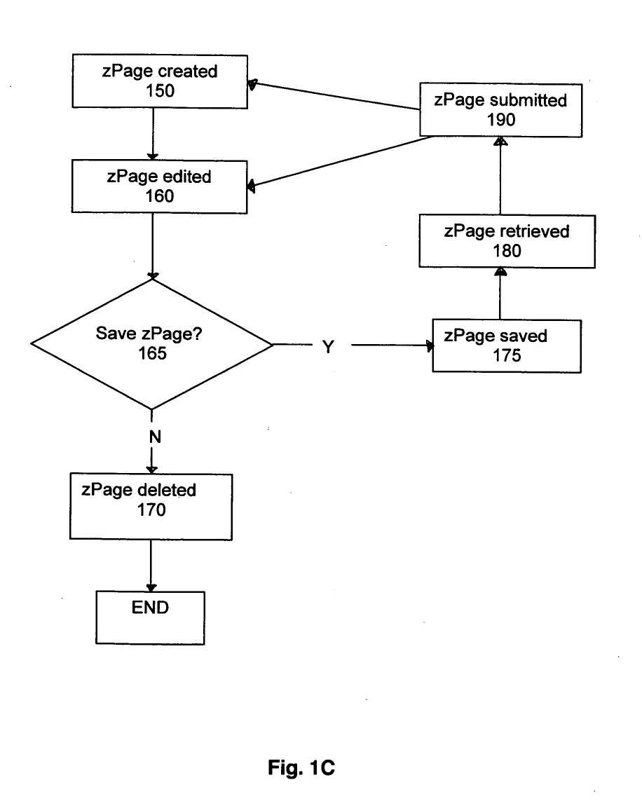

FIG. 1A is a flowchart of the zBox lifecycle generally depicting the lifecycle steps of creating a zBox 100, editing the zBox 110, deleting the zBox 120 or saving the zBox 130, and retrieving the zBox 140. More specifically, in step 100 a zBox is created from, but not limited to, script, double-click/drag/drop of URL actions, copy/paste of content, user-input, actions/triggers from other zBoxes, or through zAlgebra. In step 110 the zBox is edited using the same actions, triggers, content, etc. used to create the zBox. Next a user can choose at step 115 to delete the zBox at step 120 where the lifecycle ends. If desired, a new zBox may be created after ending the lifecycle at step 120 or as discussed below, a user may retrieve a previously saved zBox at step 140.

Alternatively, a user can choose at step 115 to save, at step 130, the zBox with the page in which it is contained or as separate blocks on the server. A saving process can be implemented using any of the actions, triggers, content, etc. used to create and edit the zBox. These same actions, triggers, content, etc. are used to retrieve a saved zBox step 140 either with the page in which it is contained or as separate blocks from the server. It should be noted that a user may start the lifecycle process by retrieving a previously saved zBox or zPage comprising the same and either editing the retrieved zBox or creating one or more other zBoxes.

With continued reference to FIG. 1A, FIG. 1B is a more detailed flowchart of step 100 in FIG. 1A and illustrates the click, drag and drop function of the zEditor to create zBoxes and/or to display content with the recursive browser or zBrowser page. In step 101 a user drops/pastes/enters the text of the content which may be, but not limited to, a URL, text or script, to trigger an action into the zCubes base layer. At step 102 zCubes logic interprets the type of the dropped content or call. This allows the wrapper HTML code or the action script to be created at step 103. Subsequently, if required, in step 104 a zBox is created and, in step 105, the HTML code created at step 103 is inserted into the document object model (DOM) or into the created zBox, as required, or, alternatively, steps to run the script are created. The process may be repeated in step 106.

More specifically, zBox creation can be implemented by double clicking on the empty space, i.e., the clipboard content is processed as if it is a drag-and-drop, by dragging and dropping any arbitrary javascript/html/url or other text, or by dragging and dropping from the action bar. Also, a user can implement zBox creation by clicking on a hyperlink that launches a javascript to BrowseTo a link, from the action bar or from another webpage or application to achieve the same. Once any drop option is made, zCubes logic extracts the text portion of the data that is dropped. For example, if the user drags and drops a link into the browser, the dropped information getTransferData as a ‘text’ call and returns the appropriate URL. If the user dragged and dropped a URL to a picture or movie, for example, the webpage will detect the URL link that is dropped. zCubes detect the type of the URL by intelligent parsing and form html tags that can be used to display or activate the content of the link.

For example, if a picture link is dropped, e.g. http://www.bitsofcode.com/logo.gif, then the zCubes will detect that it is a potential picture, create a new zBox and wrap the dropped URL in sufficient html to display or to activate it. In this case, this wrapping code would be <DIV><IMG SRC=“http://www.bitsofcode.com/logo.gif”><IMG></DIV>. That is the incoming URL is put into the template <DIV><IMG SRC=“[PICTUREURL]”><IMG></DIV>.

Every content type that is supported has a similar template. Each dropped content is converted into a zBox with wrapper code in HTML that can then be rendered or acted on by the browser capabilities. If a support application is required, e.g., SHOCKWAVE or PDF or WORD or other applications, for a link of type .html, then enough HTML is composed using, for example, TEXTBOX, DIV or IFRAME, to wrap the content and display it safely. If the content dropped is a text of arbitrary length, then zCubes will try to interpret the type of text and the appropriate display or action for it. For example, if the text is a potential script, then zCubes will try to execute it or form enough html tags to keep it potentially executable.

FIG. 1C is a flowchart of the zPage lifecycle generally depicting the lifecycle steps of creating a zPage 150, editing the zPage 160, deleting the zPage 170 or saving the zPage 175, retrieving the zPage 180, and submitting the zPage 190. More specifically, in step 150 a zPage is created from a new instance of a website page displayed within a recursive browser window. In step 160 the zPage is edited using a variety of applicable zCubes. Next a user can choose to delete the zPage at step 170 where the lifecycle ends. If desired, a new zPage may be created after ending the lifecycle at step 170 or as discussed below, a user may retrieve a previously saved zPage at step 180.

Alternatively, at step 165 a user can choose to save, at step 175, a zPage in pure DHTML as one page or several components comprising the entirety. The zPage or components thereof may be saved to, but not limited to, a local drive, a jump drive, to the Internet, to email or to other persistent media. Only data is generally saved and not the zCube full logic. In step 180 a saved zPage is retrieved in its entirety or as separate blocks from the server on which it is stored and contains primarily data. Once retrieved, in step 190 the zPage is submitted to a zCubes server to attach the logic of the zCubes world to the basic data in the zPages. It should be noted that a user may start the lifecycle process by retrieving and submitting a previously saved zPage and either editing the retrieved zPage or creating one or more other zPages within the browser window or from the submitted zPage.

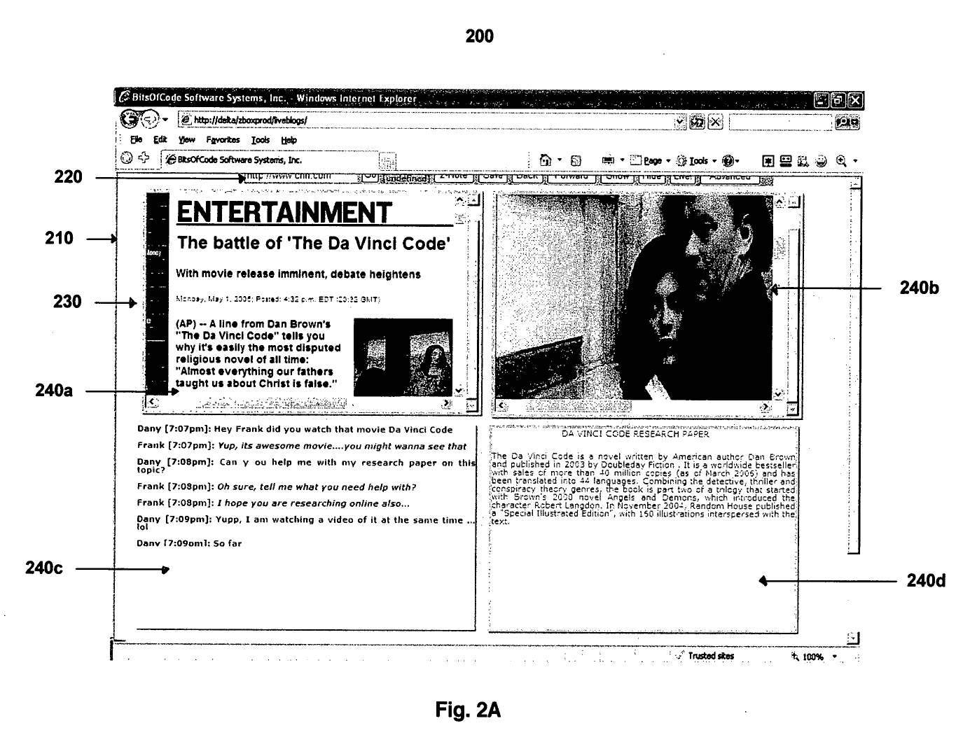

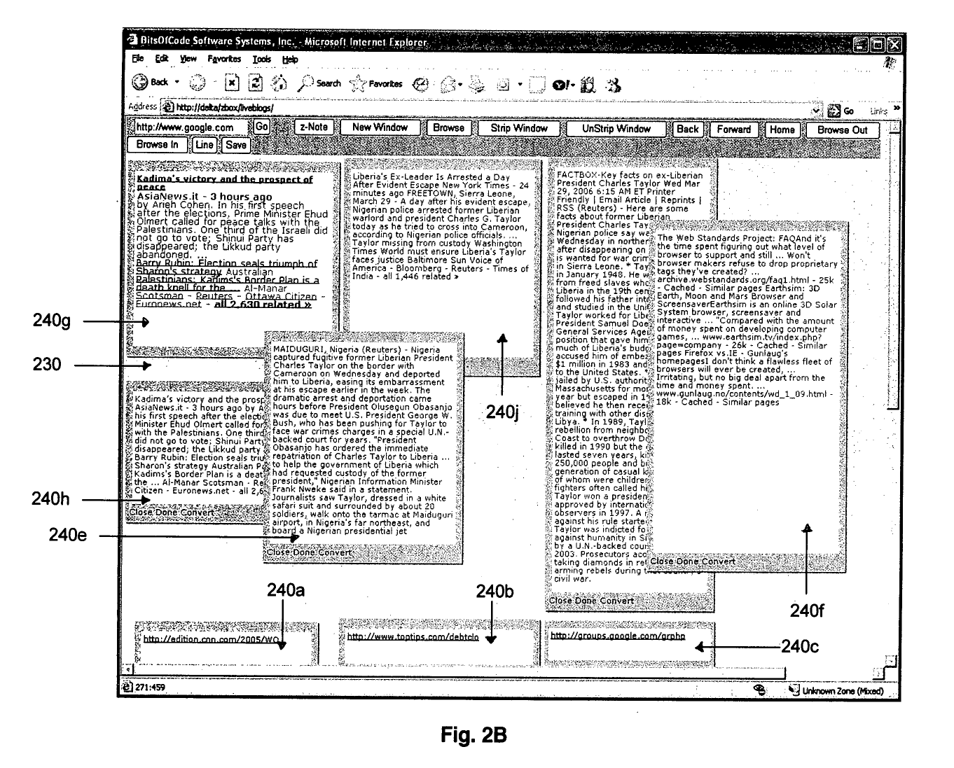

FIGS. 2A-2B illustrate the different types of content that can be interactively and simultaneously displayed within a recursive browser or zBrowser page. FIG. 2A is a zBrowser 200 showing a zBrowser window 210 including an Action Bar 220 and a zBrowser page 230. The page 230 comprises an array of four zNotes 240 displayed as zFrames containing an article 240a, a movie 240b, live chat or messaging 240c, and the start of a research paper 240d. A zNote contains a zFrame which contains a web page or other content. In this example, a user may use the displayed contents as research tools to create the research paper 240d. Furthermore, the ability to chat or message while perusing the article and/or the movie provides an additional resource.

With continued reference to FIG. 2A, FIG. 2B demonstrates that zFrames and zBoxes displayed within a zBrowser page 230 can be positioned in any user-determined x-, y- and z-orientation to suit the immediate requirements of the user. As shown frames 240e,f and zBoxes 250a,b,c are positioned such that the user may immediately access the content. The zFrames 240g-j may be brought forward within the page, as needed by clicking thereon.

One skilled in the art will appreciate readily that the present invention is well adapted to carry out the objects and obtain the ends and advantages inherent herein. The present examples, along with the methods, procedures, systems, and/or applications described herein are presently representative of preferred embodiments, are exemplary and are not intended as limitations on the scope of the invention. Changes therein and other uses will occur to those skilled in the art which are encompassed within the spirit of the invention as defined by the scope of the claims.

What is claimed is:

1. A recursive browser system, comprising:
a recursive web browser configured to recursively display one or more web pages in a browser window thereof;
means for interactively editing content within the browser window; and
means for storing said edited content on a computer storage medium.

2. The recursive browser system of claim 1, further comprising means for launching a user-requested action.

3. The recursive browser system of claim 2, wherein said means for launching a user-requested address action is an action bar within a recursive browser window or an address bar located in a browser platform associated with the recursive web browser which triggers the action bar.

4. The recursive browser system of claim 1, wherein said means for editing content comprises:
a process for dragging and dropping one or more web objects or html code into the browser window and transforming said object(s) or html code into one or more zBoxes or zCubes; or
a process for creating an object within a zFrame of said browser window; or
a combination thereof.

5. The recursive browser system of claim 4, further comprising a process for displaying said dropped object(s) within said zBox(es) or zFrames.

6. The recursive browser system of claim 4, further comprising a process for user-implemented positioning of said said zBox(es) or zFrames within the browser window.

7. The recursive browser system of claim 4, further comprising a process for separately saving one or more of said zBox(es) or zFrames containing said dropped object(s) as a file, a zBlock or an email or to other computer storage media.

8. The recursive browser system of claim 4, further comprising a process for saving the entirety of said objects within the browser window as a retrievable user-interactive zPage.

9. The recursive browser system of claim 4, wherein said dropped object is a hyperlink or URL, script, an action or a locator contained within a zBox in said browser window.

10. The recursive browser system of claim 4, wherein said dropped object is a text, an image displayed within a zBox or zFrame in said browser window.

11. The recursive browser system of claim 4, wherein said user-created object is a text or a drawing or handwritten content in VML, VRML or SVG.

12. A recursive web browser, comprising:
a browser window configured to recursively display one or more web pages therewithin;
means for launching a user-requested address or action;
means for interactively editing content within the browser window; and
means for storing said edited content to a computer storage medium.

13. The recursive web browser of claim 12, wherein said means for launching a user-requested address action is an action bar within a recursive browser window or an address bar located in a browser platform associated with the recursive web browser which triggers the action bar.

14. The recursive web browser of claim 12, wherein said means for editing content comprises:
a process for dragging and dropping one or more web objects or html code into the browser window and transforming said object(s) or html code into one or more zBoxes or zCubes; or
a process for creating an object within a zFrame of said browser window; or
a combination thereof.

15. The recursive web browser of claim 14, further comprising a process for displaying said dropped object(s) within said zBox(es) or zFrames.

16. The recursive web browser of claim 14, further comprising a process for user-implemented positioning of said zBox(es) or zFrames within the browser window.

17. The recursive web browser of claim 14, further comprising a process for separately saving one or more of said zBox(es) or zFrames containing said dropped object(s) as a file, a zBlock or an email or to other computer storage media.

18. The recursive web browser of claim 14, further comprising a process for saving the entirety of said objects as a retrievable user-interactive zPage.

19. The recursive web browser of claim 14, wherein said dropped object is a hyperlink or URL, script, an action or a locator contained within a zBox in said browser window.

20. The recursive web browser of claim 14, wherein said dropped object is a text, an image displayed within a zBox or zFrame in said browser window.

21. The recursive web browser of claim 14, wherein said user-created object is a text or a drawing or handwritten content in virtual modeling language.

22. A user-implemented method for interactively manipulating content within a recursive browser environment, comprising:
dragging and dropping one or more web objects as one or more zBoxes or zFrames within a browser window of the recursive web browser of claim 12 thereby interactively manipulating said content within the recursive browser environment.

23. The user-implemented method of claim 22, wherein said recursive browser environment comprises zCubes.

24. The user-implemented method of claim 22, further comprising positioning said zBox(es) or zFrames at any user-determined location within the browser window.

25. The user-implemented method of claim 22, wherein said object(s) is a hyperlink or URL dropped as a zBox, the method further comprising:
retrieving and displaying the web page(s) associated with said hyperlink(s) or URL(s) in one or more zFrames.

26. The user-implemented method of claim 22, wherein said object(s) is text or an image, the method further comprising:
displaying the object(s) in a zFrame within the browser window.

27. The user-implemented method of claim 22, wherein said object(s) is an action(s) dropped in a zBox, the method further comprising:
implementing the action(s) within the browser window or within the zFrames therein.

28. The user-implemented method of claim 27, wherein said action is an event model, a script model, drag-drop formatting, or style formatting.

29. The user-implemented method of claim 22, further comprising saving one or more of said zBoxes or zFrames as one or more files, zBlocks or emails or to other computer-storage media or saving the entirety of said zBoxes and zFrames as a retrievable user-interactive zPage.

30. A user-implemented method for interactively manipulating content within a recursive browser environment, comprising:
opening one or more zFrames, zBoxes, zCubes or a combination thereof within a browser window of the recursive web browser of claim 12, and
adding one or more user-created objects therein, thereby interactively manipulating said content within the recursive browser environment.

31. The user-implemented method of claim 30, wherein said recursive browser environment comprises zCubes.

31. The user-implemented method of claim 29, further comprising positioning said zFrames at any user-determined location within the browser window.

32. The user-implemented method of claim 29, further comprising saving one or more of said zFrames as one or more files, emails or other media or the entirety of said objects as a retrievable user-interactive zPage.

33. The user-implemented method of claim 29, wherein said object(s) is text, a drawing or handwritten content using VML, VRML or SVG.
